(19) United States
(12) Patent Application Publication
(10) Pub. No.: US 2026/0028108 A1
(43) Pub. Date: Jan. 29, 2026

(54) MOUNTING ASSEMBLY FOR A WATERCRAFT AND WATERCRAFT HAVING THE SAME

(71) Applicant: BOMBARDIER RECREATIONAL PRODUCTS INC., Valcourt (CA)

(72) Inventors: Garrett Edward MORGAN, Valcourt (CA); Kevin GIGUERE, Racine (CA); Felix-Antoine CHARTRAY, Danville (CA)

(21) Appl. No.: 19/267,049

(22) Filed: Jul. 11, 2025

Related U.S. Application Data
(60) Provisional application No. 63/676,617, filed on Jul. 29, 2024.
(60) Provisional application No. 63/683,815, filed on Aug. 16, 2024.

(51) Int. Cl. B63H 20/06; B63H 20/00; B63H 20/10; F16M 13/02

(52) U.S. Cl. CPC B63H 20/06; B63H 20/10; F16M 13/022; B63H 20/007

(57) ABSTRACT

A mounting assembly for selectively mounting a trolling motor to a watercraft and the watercraft. The mounting assembly includes a base to fixedly connect to a deck of the watercraft. The base having a base interlocking feature and defining a first plane. The mounting assembly includes a top plate to connect to the trolling motor and selectively coupled to the base. The top plate having a top plate interlocking feature. In response to moving the top plate in a first direction, the top plate and base interlocking features engage, coupling the top plate to the base to prevent uncoupling along a second plane. The mounting assembly includes a latch moveable between a locked position, preventing movement of the top plate in a second direction and an unlocked position, in which, with the top plate coupled to the base, the top plate can move in the second direction.

### CROSS REFERENCE

The present application claims priority to the U.S. Provisional Patent Application No. 63/676,617, filed Jul. 29, 2024, entitled “MOUNTING ASSEMBLY FOR A WATERCRAFT AND WATERCRAFT HAVING THE SAME”, and to the U.S. Provisional Application No. 63/683,815, filed on Aug. 16, 2024, entitled “MOUNTING ASSEMBLY FOR A WATERCRAFT AND WATERCRAFT HAVING THE SAME”, which are incorporated by reference herein in their entirety.

### FIELD OF TECHNOLOGY

The present technology relates to watercraft having a mounting assembly for a trolling motor.

### BACKGROUND

Trolling motors allow for precise control and low-speed maneuverability of boats, such as pontoons, which are often used for fishing and leisure water activities. Often, trolling motors are permanently fixed to a deck of the pontoon using screws or bolts, making maintenance and/or replacement labor-intensive and time-consuming. This lack of flexibility can be an issue for boaters who may need to quickly remove or switch motors, for example to switch a more powerful motor for travel.

In some cases, mounting systems have been developed to facilitate the mounting and removal of the trolling motor. However, these systems often require tools for attachment and detachment and consist of multiple loose components such as pins, screws, and clips which can be easily lost when the trolling motor is disconnected, reducing the convenience and practicality of these mounting systems.

In view of the foregoing, there is a need for a mounting assembly for a watercraft that addresses at least some of these drawbacks.

### SUMMARY

It is an object of the present technology to ameliorate at least some of the inconveniences present in the prior art.

According to an aspect of the present technology, there is provided a mounting assembly for selectively mounting a trolling motor to a watercraft. The mounting assembly includes a base configured to fixedly connect to a deck of the watercraft, the base having at least one base interlocking feature and defining a first plane; a top plate configured to connect to the trolling motor, the top plate being selectively coupled to the base, the top plate having at least one top plate interlocking feature, in response to moving the top plate in a first direction along the first plane, the at least one top plate interlocking feature engaging with the at least one base interlocking feature, thereby coupling the top plate to the base to prevent uncoupling of the top plate from the base along a second plane, the second plane being orthogonal to the first plane; and a latch connected to the base and moveable between: a locked position, in which, with the top plate coupled to the base, a portion of the latch interferes with a portion of the top plate, preventing movement of the top plate in a second direction along the first plane, the second direction being opposite to the first direction; and an unlocked position, in which, with the top plate coupled to the base, the top plate can move in the second direction.

In some embodiments, the top plate includes: a body having a bottom surface; and an extension connected to the body and extending away from the bottom surface; the base includes a surface, the surface defining at least one opening; the at least one top plate interlocking feature includes at least one projection connected to the extension and extending laterally away from the extension, the at least one projection configured to be received in the at least one opening; and the at least one base interlocking feature includes at least one contact portion of the surface, such that in response to moving the top plate in the first direction, the at least one projection is positioned under the at least one contact portion, and subsequent movement of the top plate along the second plane causes the at least one projection to contact the at least one contact portion, thereby preventing uncoupling of the top plate from the base along the second plane.

In some embodiments, the extension is connected to the bottom surface of the top plate and extends along a length of the bottom surface.

In some embodiments, the surface defines a channel connected to the at least one opening; and the channel is configured to receive the extension.

In some embodiments, the at least one opening includes a plurality of cut-outs extending from an edge of the channel and spaced apart from one another, each pair of cut-outs of the plurality of cut-outs forming a tab portion therebetween; the at least one projection includes a plurality of projections spaced apart from one another along a length of the extension; each cut-out of the plurality of cut-outs is configured to receive a corresponding projection of the plurality of projections; and the at least one contact portion of the surface includes the tab portions.

In some embodiments, the plurality of cut-outs includes three cut-outs; and the plurality of projections includes three projections.

In some embodiments, the plurality of projections are trapezoidal; and each tab portion formed between the pairs of cut-outs is trapezoidal.

In some embodiments, the surface is a top surface of the base.

In some embodiments, the top plate includes: a body having a bottom surface; a first extension connected to the bottom surface and extending away from the bottom surface, the first extension extending along a first length of the bottom surface; and a second extension connected to the bottom surface and extending away from the bottom surface, the second extension being spaced apart from the first extension and extending along a second length of the bottom surface; the base includes a surface, the surface defining: a first channel configured to receive the first extension; a first set of cut-outs extending from an edge of the first channel and spaced apart from one another, each pair of cut-outs of the first set of cut-outs forming a first tab portion therebetween; a second channel configured to receive the second extension; and a second set of cut-outs extending from an edge of the second channel and spaced apart from one another, each pair of cut-outs of the first set of cut-outs forming a second tab portion therebetween; the at least one top plate interlocking feature includes: a first set of projections connected to the first extension and extending laterally away from the first extension, each projection of the first set of projections is configured to be received in a corresponding cut-out of the first set of cut-outs; and a second set of projections connected to the second extension and extending laterally away from the second extension, each projection of the second set of projections is configured to be received in a corresponding cut-out of the second set of cut-outs; and the at least one base interlocking feature includes: the first tab portions; and the second tab portions; in response to moving the top plate in the first direction, the first set of projections are positioned under the first tab portions, and the second set of projections are positioned under the second tab portions.

In some embodiments, the latch is pivotably connected to the base such that the latch pivots between the locked position and the unlocked position.

In some embodiments, the top plate defines a notch; and the latch includes a protrusion configured to be received in the notch when the latch is in the locked position.

In some embodiments, the notch is defined on one of the at least one top plate interlocking feature.

In some embodiments, a shape of the notch and a shape of the protrusion are complementary to one another.

In some embodiments, the latch includes a biasing member biasing the latch toward the locked position, such that in response to moving the top plate in the first direction, the latch biases to the locked position.

In some embodiments, the latch has a pivot end pivotably connected to the base; and the biasing member is a resilient arm extending outwardly from the pivot end.

In some embodiments, the first direction is a longitudinal direction along a length of the base.

In some embodiments, the base includes stoppers to limit movement of the top plate in the first direction.

According to another aspect of the present technology, there is provided a watercraft. The watercraft includes a hull; a deck supported by the hull; a mounting assembly connected to the hull, the mouthing assembly having: a base fixedly connected to the deck, the base having at least one base interlocking feature and defining a first plane; a top plate selectively coupled to the base, the top plate having at least one top plate interlocking feature, in response to moving the top plate in a first direction along the first plane, the at least one top plate interlocking feature engaging with the at least one base interlocking feature of the base, thereby coupling the top plate to the base to prevent uncoupling of the top plate from the base along a second plane, the second plane being orthogonal to the first plane; and a latch connected to the base and moveable between: a locked position, in which, with the top plate is coupled to the base, a portion of the latch interferes with a portion of the top plate, preventing movement of the top plate in a second direction along the first plane, the second direction being opposite the first direction; and an unlocked position, in which, with the top plate is coupled to the base, the top plate can move in the second direction; and a trolling motor connected to the top plate of the mounting assembly.

According to another aspect of the present technology, there is provided a trolling motor assembly configured to mount to a watercraft. The trolling motor assembly includes a trolling motor; and a mounting assembly having: a base configured to fixedly connect to a deck of the watercraft, the base having at least one base interlocking feature and defining a first plane; a top plate selectively coupled to the base and to the trolling motor, the top plate having at least one top plate interlocking feature, in response to moving the top plate in a first direction along the first plane, the at least one top plate interlocking feature engaging with the at least one base interlocking feature of the base, thereby coupling the top plate to the base to prevent uncoupling of the top plate from the base along a second plane, the second plane being orthogonal to the first plane; and a latch connected to the base and moveable between: a locked position, in which, with the top plate coupled to the base, a portion of the latch interferes with a portion of the top plate, preventing movement of the top plate in a second direction along the first plane, the second direction being opposite the first direction; and an unlocked position, in which, with the top plate coupled to the base, the top plate can move in the second direction.

According to another aspect of the present technology, there is provided a mounting assembly for selectively mounting a device to an object, the mounting assembly including: a base configured to fixedly connect to the object, the base having at least one base interlocking feature and defining a first plane; a top plate configured to connect to the device, the top plate being selectively coupled to the base, the top plate having at least one top plate interlocking feature, in response to moving the top plate in a first direction along the first plane, the at least one top plate interlocking feature engaging with the at least one base interlocking feature, thereby coupling the top plate to the base to prevent uncoupling of the top plate from the base along a second plane, the second plane being orthogonal to the first plane; and a latch connected to the base and moveable between: a locked position, in which, with the top plate coupled to the base, a portion of the latch interferes with a portion of the latch interferes with a portion of the top plate, preventing movement of the top plate in a second direction along the first plane, the second direction being opposite the first direction; and an unlocked position, in which, with the top plate coupled to the base the top plate can freely move along the first plane.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

For purposes of this application, terms related to spatial orientation such as forwardly, rearward, upwardly, downwardly, left, and right, are as they would normally be understood by a driver of the watercraft sitting thereon in a normal driving position. Terms related to spatial orientation when describing or referring to components or sub-assemblies of the vehicle, separately from the watercraft should be understood as they would be understood when these components or sub-assemblies are mounted to the watercraft, unless specified otherwise in this application. The phrase “at least one of A and B” should be understood to mean “only A, only B, or both A and B”.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a top, front, left side of a pontoon boat in accordance with an embodiment of the present technology;

FIG. 2 is a perspective view taken from a top, rear, right side of a trolling motor on a mounting assembly of the pontoon boat of FIG. 1, the trolling motor being in a raised position;

FIG. 3 is a perspective view taken from a top, rear, right side of the mounting assembly of FIG. 2;

FIG. 4 is an exploded view taken from a top, rear, right side of the mounting assembly of FIG. 2;

FIG. 5 is an exploded view taken from a bottom, rear, right side of the mounting assembly of FIG. 2;

FIG. 6 is an exploded view taken from a rear elevation view of the mounting assembly of FIG. 2;

FIG. 7 is a rear elevation view of the mounting assembly of FIG. 2, with a latch in the locked position;

FIG. 8 is a cross-sectional view taken along line 8-8 of FIG. 7 of the mounting assembly of FIG. 2;

FIG. 9 is a rear elevation view of the mounting assembly of FIG. 2, with the latch in the unlocked position and a top plate arranged to be uncoupled from a base member; and

FIG. 10 is a cross-sectional view taken along line 10-10 of FIG. 9 of the mounting assembly of FIG. 2, with the latch in the unlocked position and a top plate arranged to be uncoupled from a base member.

### DETAILED DESCRIPTION

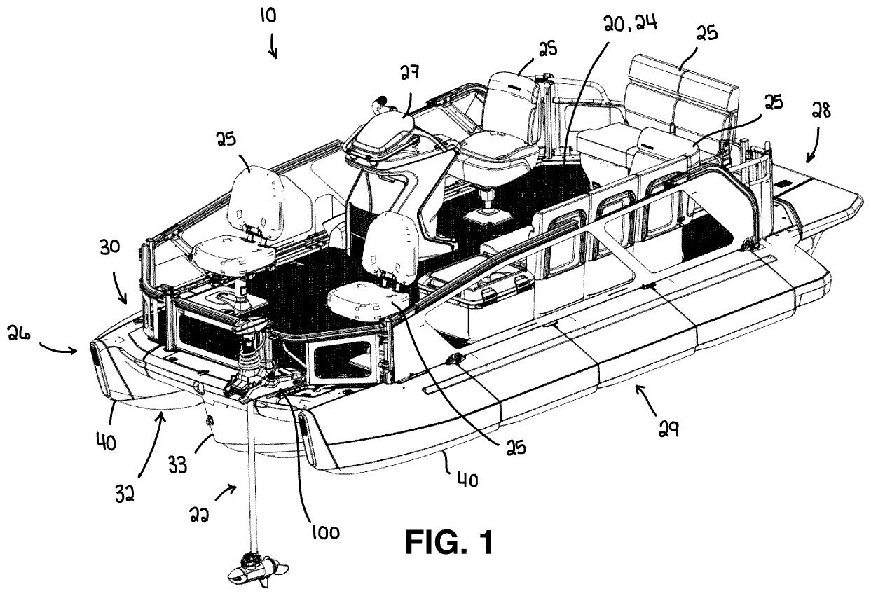

A watercraft 10 in accordance with one embodiment of the present technology is shown in FIG. 1. The following description relates to one example of a watercraft 10, notably a pontoon boat 10, referred to hereinafter as a boat 10. Those of ordinary skill in the art will recognize that there are other known types of watercraft incorporating different designs and that the present technology would encompass these other watercraft.

The boat 10 has a deck 20 and a hull 32 supporting the deck 20. In this embodiment, the hull 32 is formed by three separate laterally adjacent portions that are connected to one another, making the boat 10 a multi-hull pontoon. Specifically, the hull 32 has a central portion 33 flanked by left and right lateral portions 40. It is contemplated that, in alternative embodiments, the hull 32 may be a single integral portion.

The deck 20 is supported by and extends above the hull 32. The deck 20 has a floor 24 extending over an upper surface of the deck 20 for supporting occupants, as well as accessories and accommodations of the boat 10, such as various seats 25 and a command console 27. In this embodiment, the seats 25 include a combination of stools, benches, and swivel seats configured to selectively attach to the floor 24. It is contemplated that a different combination of accessories may be selected in other embodiments.

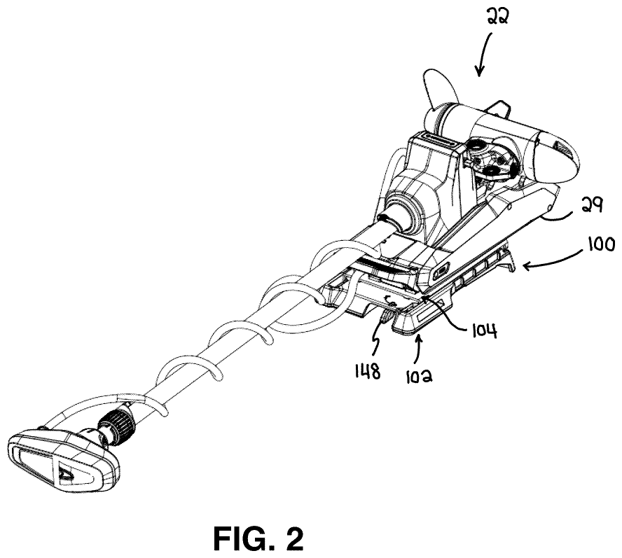

The boat 10 includes a secondary motor 22, such as a trolling motor 22 (referred to hereinafter as motor 22) for low-speed maneuvering of the boat 10. In this embodiment, the motor 22 is mounted to a front end 26 (bow) of the boat 10. However, in alternative embodiments, the motor 22 may be mounted to a rear end 28 (stern) or side of the boat 10. The motor 22 is configured to pivot smoothly between a deployed positioned (as depicted in FIG. 1) and a raised position (as depicted in FIG. 2), enabling quick and easy stowage and deployment. It is contemplated that, in other embodiments, the motor 22 may not be configured to be pivotably deployed and raised.

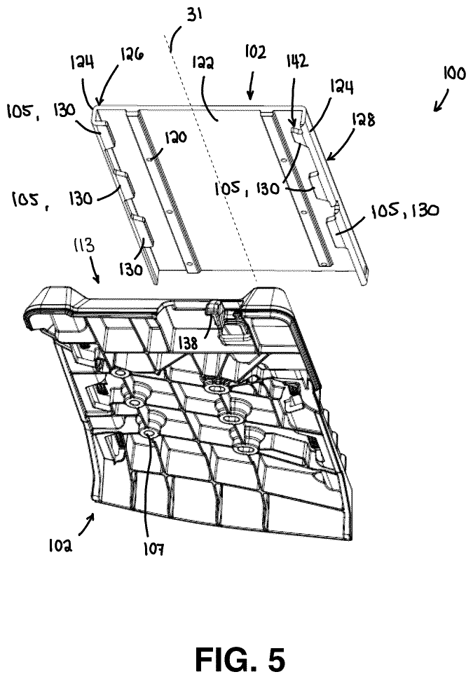

With specific reference to FIGS. 2 to 10, a mounting assembly 100 will now be described in detail. Broadly, the mounting assembly 100 includes a base 102 having a base interlocking feature 103 and a top plate 104 having a top plate interlocking feature 105. When the base 102 and the top plate 104 are coupled together, the base interlocking feature 103 engages with the top plate interlocking feature 105 to prevent uncoupling of the top plate 104 from the base 102. Although the mounting assembly 100 is described hereinafter for quick connecting the motor 22 to the deck 20 of the boat 10, it is noted that the mounting assembly 100 may be configured to mount other boating accessories, including but not limited to electronics or navigation systems to a dashboard of the console 27, and seats or storage compartments onto the upper surface 24 of the deck 20. It is also contemplated that in some embodiment, the mounting assembly 100 may be configured to mount a device other than a boating accessory to an object other than a boat.

The base 102 is configured to fixedly connect with the deck 20 of the boat 10. In the present embodiment, the base 102 has a generally trapezoidal prism shape, where a top surface 106 of the base 102 is substantially planar. It is contemplated that the shape of the base 102 may be different in different embodiments. The base 102 is fixedly connected to the deck 20 using fasteners (not depicted) such as bolts or screws which are inserted into apertures 107 defined in the top surface 110. It is contemplated that the base 102 may be connected to the deck 20 differently in different embodiments, for example using an adhesive.

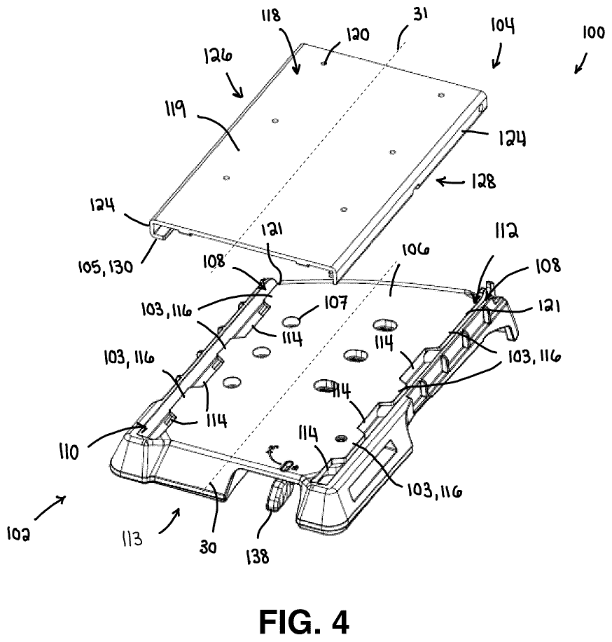

With specific reference to FIG. 4, the top surface 106 defines two channels 108, with each channel 108 being positioned along a lateral edge of the top surface 106. Specifically, one channel 108 extends longitudinally along a left edge 111. The other channel 108 extends longitudinally along a right edge 112. The top surface 106 further defines at least one opening 114, and more specifically in this embodiment two sets of cut-outs 114. Each set of cut-outs 114 is connected to a respective channel 108. Each of the channels 108 and the cut-outs 114 connected to the channel 108 have a similar configuration. As such, for clarity, only the right channel 108 with cut-outs 114 will be described in detail.

In this embodiment, the top surface 106 defines three cut-outs 114. Each cut-out 114 extends from an inner edge 121 of the channel 108 towards a center line 30 of the top surface 110. The cut-outs 114 are positioned along a length of the channel 108. Each cut-out 114 is spaced apart from an adjacent one, forming a contact portion 116 therebetween. In this embodiment, the contact portion 116 is a tab portion 116. The tab portion 116, corresponding to the base interlocking feature 103 in this embodiment, is configured to contact and engage with the top plate 104, which is described in detail below. In the present embodiment, the cut-outs 114 are trapezoidal, tapering towards the center line 30. Consequently, the tab portion 116 formed between the pair of cut-outs 114 is trapezoidal, tapering towards the channel 108. It is noted that the shape and number of the cut-outs 114 and tab portions 116 may vary in other embodiments.

The top plate 104 will now be described in detail. The top plate 104 is configured to connect with a bottom 29 of the motor 22. In this embodiment, the top plate 104 has a substantially planar body 118. The top plate 104 is fixed to the bottom 29 via fasteners, such as screws or bolts (not depicted) inserted into apertures 120 defined in a top surface 119 of the top plate 104. It is contemplated that the top plate 104 may be connected to the bottom 29 of the motor 22 differently in different embodiments, for example using LinQ™ fastener from Bombardier Recreational Products Inc.

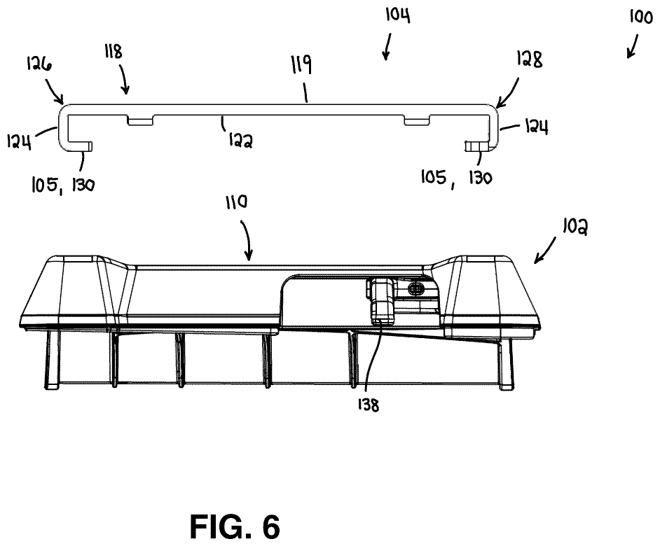

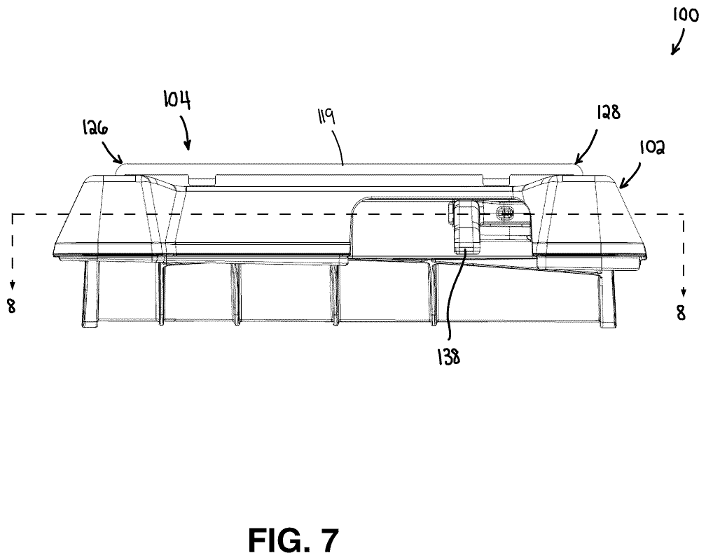

With specific reference to FIGS. 6 and 7, the top plate 104 includes two extensions 124 connected to the body 118 and extending downwards, away from a bottom surface 122. Each extension 124 is positioned along a lateral edge of the top plate 104. Specifically, one extension 124 extends longitudinally along a left edge 126. The other extension 124 extends longitudinally along a right edge 128. Each extension 124 is configured to be slidably received in a respective channel 108 of the base 102, which is described in further detail below. A set of projections 130 is disposed on each of the extensions 124. The projections 130, corresponding to the top plate interlocking feature 105 in this embodiment, are configured to contact and engage with the tab portions 116, which is described in further detail below. Each of the extensions 124 and the projections 130 have a similar configuration. Therefore, for clarity only the right extension 124 with the projections 130 will be described in detail.

In this embodiment, the extension 124 includes three projections 130. Each projection 130 extends from an inner edge 132 of the extension 124 towards a center line 31 of the of the bottom surface 122. The projections 130 are planar and extend parallel to the bottom surface 122. The projections 130 are positioned along a length of the extension 124 and spaced apart from one another. Each projection 130 is configured to be received in a respective cut-out 114 of the base 102. Thus, the projections 130 are complementary in shape to the cut-outs 114. That is, each projection 130 is trapezoidal, tapering towards the center line 31. It is noted that the shape and number of the projections 130 may vary in other embodiments.

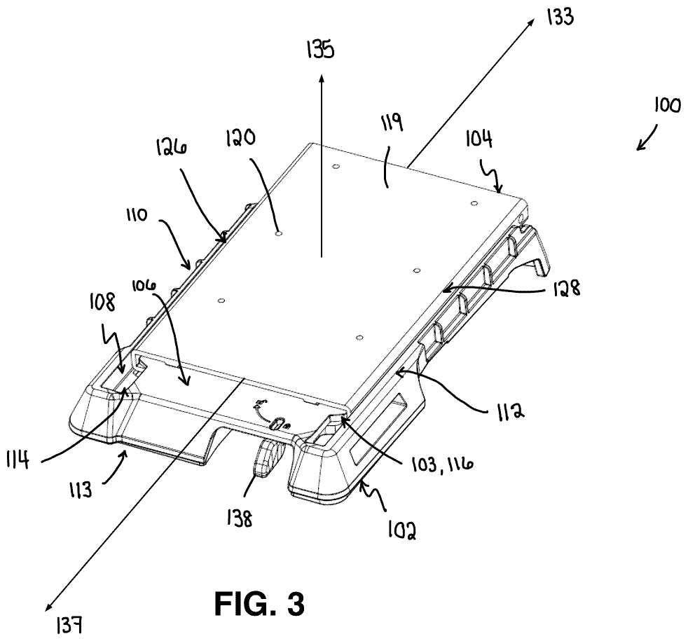

To couple the top plate 104 to the base 102, the projections 130 are received by the cut-outs 114 and the top plate 104 is translated longitudinally (denoted by arrow 133 in FIG. 3) relative to the base 102. That is, the top plate 104 is moved forwardly relative to the base 102 in the longitudinal direction 133. In response, the extension 124 is slidably received in the channel 108. Each projection 130 is now below and aligned with a respective tab portion 116 of the base 102. As such, movement upwardly (denoted by arrow 135 in FIG. 3) is restricted, preventing uncoupling of the top plate 102 from the base 104 in the vertical direction 135. Specifically, if the top plate 104 is moved in the upward direction 135, each projection 130 contacts the corresponding tab portion 116, preventing further movement in the upward direction 135. As the motor 22 is connected to the top plate 104 and the base 102 is fixed to the deck 20, when the top plate 104 is coupled to the base 102, the motor 22 is mounted to the deck 20 and secured from being lifted in the upwards direction 135.

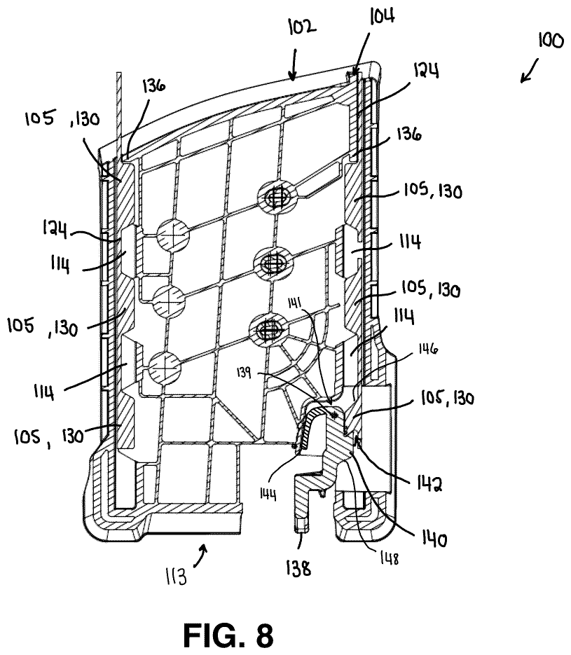

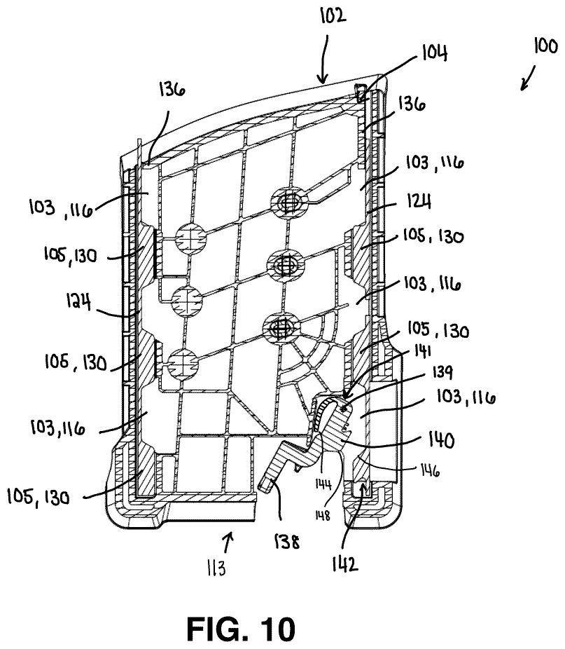

As depicted in FIGS. 8 and 10, the base 102 includes stoppers 136 configured to limit further movement of the top plate 104 in the forward direction 133. Specifically, each stopper 136 is positioned to contact the most forward projection 130 on each extension 124 when the top plate 104 is moved forwardly relative to the base 102, as shown in FIG. 8. This ensures the projections 130 of the top plate 104 are positioned under the tab portions 116 of the base 102 and the top plate 104 cannot be uncoupled from the base 102 (and consequently, the motor 22 cannot be uncoupled from the deck 20) in the forward direction 133.

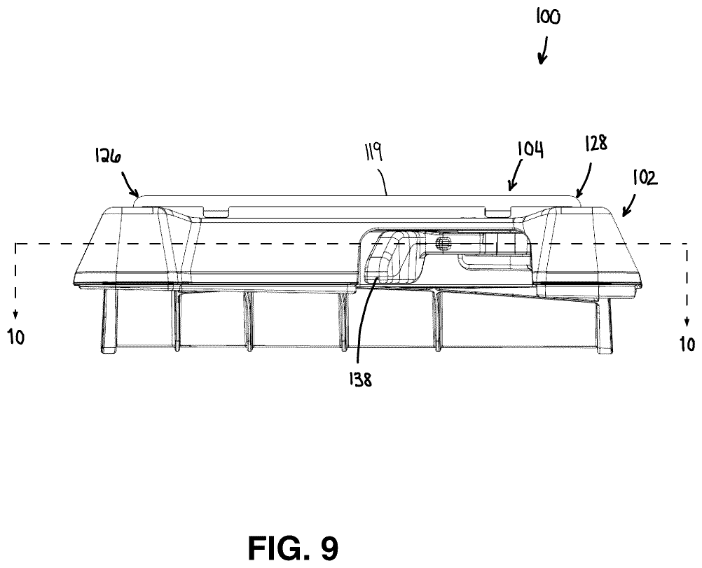

As depicted in FIGS. 7 to 10, the mounting assembly 100 includes a latch 138 moveable between a locked position (as depicted in FIGS. 7 and 8) and an unlocked position (as depicted in FIGS. 9 and 10). When the latch 138 is in the locked position, the top plate 104 is prevented from moving in a rearward direction (denoted by arrow 137 in FIG. 3). This ensures the projections 130 of the top plate 104 are positioned under the tab portions 116 of the base 102 and the top plate 104 cannot be uncoupled from the base 104 (and consequently, the motor 22 cannot be uncoupled from the deck 20) in the rearward direction 137. Thus, when the projections 130 of the top plate 104 are under and aligned with the tab portions 116 of the base 102 and the latch 138 is in the locked position, the top plate 104 is secured to the base 102. In other words, the top plate 104 cannot be uncoupled from the base 102 in the forward, upward, and rearward directions 133, 135, 137.

When the latch 138 is in the unlocked position, the top plate 104 can move in the rearward direction 137, such that the projections 130 of the top plate 104 aligns with the cut-outs 114 of the base 102, as shown in FIG. 10. This alignment allows the top plate 104 to be moved in the upwards direction 135, withdrawing the projections 130 from the cut-outs 114.

In this embodiment, the latch 138 is pivotably connected to the base 102 at a rear end 113, as such the latch 138 pivots between the locked and unlocked positions. The latch 138 is pivotably connected via a pin 139 at a pivot end 141, which defines a pivot axis of the latch 138. It is contemplated that the latch 138 may be positioned differently in different embodiments.

The latch 138 defines a protrusion 140 configured to engage a portion of the rearmost projection 130 of one of the extensions 124. In this embodiment, the latch 138 engages with the rearmost projection 130 of the extension 124 along the right edge 128 of the top plate 104. However, in other embodiments, the latch 138 may engage with a different extension 124 or a different projection 130. The rearmost projection 130 also defines a notch 142, complementary in shape with the protrusion 140 of the latch 138.

The latch 138 includes a resilient arm 144 extending outwardly from the pivot end 141 for biasing the latch 138 towards the locked position. That is, in response to the top plate 104 moving in the forward direction 133, the latch 138 is biased to the locked position. Specifically, as the top plate 104 moves in the forward direction 133, a front angled edge 146 of the rearmost projection 130 contacts and slides against a rear angled edge 148 of the latch 138. This pivots the latch 138 from a locked position to the unlocked position. In the unlocked position, the resilient arm 144 presses against an inner wall (not separately numbered) of the base 102. As the top plate 104 continues moving in the forward direction 133, the rearmost projection 130 passes the protrusion 140. The resilient arm 144 pushes the latch 138 back to the locked position, and the protrusion 140 engages with the notch 142 of the rearmost projection 130. It is noted that, even in the locked position, the resilient arm 144 is still pressing against the inner wall. As a result, the protrusion 140 applies a biasing forward onto the rearmost projection 130 in the forward direction 133, causing the frontmost projection 130 to abut the stopper 136. This tightly secures the top plate 104 longitudinally, preventing rattling between the top plate 104 and the base 102. It is contemplated that the resilient arm 144 may be omitted in other embodiments.

It is contemplated that the base interlocking feature 103 and the top plate interlocking feature 105 may be configured differently in different embodiments. In some instances, the base interlocking feature 103 and the top plate interlocking feature 105 may be configured such that the top plate 104 is coupled to the base 102 when the top plate 104 is rotated (clockwise or counter-clockwise). Alternatively, in other embodiments, the base interlocking feature 103 and the top plate interlocking feature 105 may be configured as a tongue and groove. In further alternative embodiments, the base interlocking feature 103 and the top plate interlocking feature 105 may be complementary brackets.

Modifications and improvements to the above-described embodiments of the present technology may become apparent to those skilled in the art. The foregoing description is intended to be exemplary rather than limiting.

What is claimed is:

1. A mounting assembly for selectively mounting a trolling motor to a watercraft, the mounting assembly comprising:
a base configured to fixedly connect to a deck of the watercraft, the base having at least one base interlocking feature and defining a first plane;
a top plate configured to connect to the trolling motor, the top plate being selectively coupled to the base, the top plate having at least one top plate interlocking feature,
in response to moving the top plate in a first direction along the first plane, the at least one top plate interlocking feature engaging with the at least one base interlocking feature, thereby coupling the top plate to the base to prevent uncoupling of the top plate from the base along a second plane, the second plane being orthogonal to the first plane; and
a latch connected to the base and moveable between:
a locked position, in which, with the top plate coupled to the base, a portion of the latch interferes with a portion of the top plate, preventing movement of the top plate in a second direction along the first plane, the second direction being opposite to the first direction; and
an unlocked position, in which, with the top plate coupled to the base, the top plate can move in the second direction.

2. The mounting assembly of claim 1, wherein:
the top plate comprises:
a body having a bottom surface; and
an extension connected to the body and extending away from the bottom surface;
the base comprises a surface, the surface defining at least one opening;
the at least one top plate interlocking feature comprises at least one projection connected to the extension and extending laterally away from the extension, the at least one projection configured to be received in the at least one opening; and
the at least one base interlocking feature comprises at least one contact portion of the surface, such that in response to moving the top plate in the first direction,
the at least one projection is positioned under the at least one contact portion, and subsequent movement of the top plate along the second plane causes the at least one projection to contact the at least one contact portion, thereby preventing uncoupling of the top plate from the base along the second plane.

3. The mounting assembly of claim 2, wherein the extension is connected to the bottom surface of the top plate and extends along a length of the bottom surface.

4. The mounting assembly of claim 3, wherein:
the surface defines a channel connected to the at least one opening; and
the channel is configured to receive the extension.

5. The mounting assembly of claim 4, wherein:
the at least one opening comprises a plurality of cut-outs extending from an edge of the channel and spaced apart from one another, each pair of cut-outs of the plurality of cut-outs forming a tab portion therebetween;
the at least one projection comprises a plurality of projections spaced apart from one another along a length of the extension;
each cut-out of the plurality of cut-outs is configured to receive a corresponding projection of the plurality of projections; and
the at least one contact portion of the surface comprises the tab portions.

6. The mounting assembly of claim 5, wherein:
the plurality of cut-outs comprises three cut-outs; and
the plurality of projections comprises three projections.

7. The mounting assembly of claim 5, wherein:
the plurality of projections are trapezoidal; and
each tab portion formed between the pairs of cut-outs is trapezoidal.

8. The mounting assembly of claim 2, wherein the surface is a top surface of the base.

9. The mounting assembly of claim 1, wherein:
the top plate comprises:
a body having a bottom surface;
a first extension connected to the bottom surface and extending away from the bottom surface, the first extension extending along a first length of the bottom surface; and
a second extension connected to the bottom surface and extending away from the bottom surface, the second extension being spaced apart from the first extension and extending along a second length of the bottom surface;
the base comprises a surface, the surface defining:
a first channel configured to receive the first extension;
a first set of cut-outs extending from an edge of the first channel and spaced apart from one another, each pair of cut-outs of the first set of cut-outs forming a first tab portion therebetween;
a second channel configured to receive the second extension; and
a second set of cut-outs extending from an edge of the second channel and spaced apart from one another, each pair of cut-outs of the first set of cut-outs forming a second tab portion therebetween;
the at least one top plate interlocking feature comprises:
a first set of projections connected to the first extension and extending laterally away from the first extension, each projection of the first set of projections is configured to be received in a corresponding cut-out of the first set of cut-outs; and
a second set of projections connected to the second extension and extending laterally away from the second extension, each projection of the second set of projections is configured to be received in a corresponding cut-out of the second set of cut-outs; and
the at least one base interlocking feature comprises:
the first tab portions; and
the second tab portions;
in response to moving the top plate in the first direction, the first set of projections are positioned under the first tab portions, and the second set of projections are positioned under the second tab portions.

10. The mounting assembly of claim 1, wherein the latch is pivotably connected to the base such that the latch pivots between the locked position and the unlocked position.

11. The mounting assembly of claim 1, wherein:
the top plate defines a notch; and
the latch comprises a protrusion configured to be received in the notch when the latch is in the locked position.

12. The mounting assembly of claim 11, wherein the notch is defined on one of the at least one top plate interlocking feature.

13. The mounting assembly of claim 11, wherein a shape of the notch and a shape of the protrusion are complementary to one another.

14. The mounting assembly of claim 1, wherein the latch comprises a biasing member biasing the latch toward the locked position, such that in response to moving the top plate in the first direction, the latch biases to the locked position.

15. The mounting assembly of claim 14, wherein:
the latch has a pivot end pivotably connected to the base; and
the biasing member is a resilient arm extending outwardly from the pivot end.

16. The mounting assembly of claim 1, wherein the first direction is a longitudinal direction along a length of the base.

17. The mounting assembly of claim 16, wherein the base comprises stoppers to limit movement of the top plate in the first direction.

18. A trolling motor assembly configured to mount to a watercraft, the trolling motor assembly comprising:
a trolling motor; and
a mounting assembly having:
a base configured to fixedly connect to a deck of the watercraft, the base having at least one base interlocking feature and defining a first plane;
a top plate selectively coupled to the base and to the trolling motor, the top plate having at least one top plate interlocking feature,
in response to moving the top plate in a first direction along the first plane, the at least one top plate interlocking feature engaging with the at least one base interlocking feature of the base, thereby coupling the top plate to the base to prevent uncoupling of the top plate from the base along a second plane, the second plane being orthogonal to the first plane; and
a latch connected to the base and moveable between:
a locked position, in which, with the top plate coupled to the base, a portion of the latch interferes with a portion of the top plate, preventing movement of the top plate in a second direction along the first plane, the second direction being opposite the first direction; and
an unlocked position, in which, with the top plate coupled to the base, the top plate can move in the second direction.

19. A mounting assembly for selectively mounting a device to an object, the mounting assembly comprising:
a base configured to fixedly connect to the object, the base having at least one base interlocking feature and defining a first plane;
a top plate configured to connect to the device, the top plate being selectively coupled to the base, the top plate having at least one top plate interlocking feature,
in response to moving the top plate in a first direction along the first plane, the at least one top plate interlocking feature engaging with the at least one base interlocking feature, thereby coupling the top plate to the base to prevent uncoupling of the top plate from the base along a second plane, the second plane being orthogonal to the first plane; and
a latch connected to the base and moveable between:
a locked position, in which, with the top plate coupled to the base, a portion of the latch interferes with a portion of the latch interferes with a portion of the top plate, preventing movement of the top plate in a second direction along the first plane, the second direction being opposite the first direction; and
an unlocked position, in which, with the top plate coupled to the base the top plate can freely move along the first plane.
